(19) United States
(12) Patent Application Publication
(10) Pub. No.: US 2014/0191085 A1
(43) Pub. Date: Jul. 10, 2014

(54) OUTER FUEL TANK ACCESS COVER, WING AND AIRCRAFT

(71) Applicant: Airbus Operations S.L., Madrid (ES)

(72) Inventors: Marcos Alazraki, Madrid (ES); Jose Sanz Torrijos, Madrid (ES)

(21) Appl. No.: 14/136,725

(22) Filed: Dec. 20, 2013

(30) Foreign Application Priority Data
Dec. 21, 2012 (EP) 12382523.4

(51) Int. Cl. B64D 37/06

(52) U.S. Cl. CPC B64D 37/06
USPC 244/135 R; 220/212

(57) ABSTRACT

An outer fuel access tank cover (FTAC) of an aircraft, a wing comprising such outer FTAC of an aircraft and an aircraft are provided. In one example, an outer fuel tank access cover (FTAC) (4) of an aircraft includes an inner surface and an outer surface. The outer FTAC is to cover the outer opening of a void area of a manhole for accessing the interior of a wing of an aircraft in which the interior of the wing comprises a fuel tank. The outer FTAC comprises absorption means adapted for absorbing the impact energy due to an object impacting against the outer FTAC.

### CROSS-REFERENCE TO RELATED APPLICATION

This application claims priority to European Patent Application No. EP 12382523.4, filed Dec. 21, 2012, which is incorporated herein by reference in its entirety.

### TECHNICAL FIELD

This application pertains to an outer fuel access tank cover (FTAC) of an aircraft, a wing comprising such outer FTAC of an aircraft and an aircraft. The technical field relates to the field of designing auxiliary pieces in the wings of aircraft to control the risk of impact against an inner FTAC when an impact occurs against the outer FTAC. In one example, this impact can be caused by a tire.

### BACKGROUND

Generally, manholes in an aircraft provide access to the fuel tank. Manholes comprise an inner fuel tank access cover (inner FTAC), an outer FTAC and a void area between the two covers. Fuel Tank Access Covers (FTACs) are mechanically fastened, with fasteners, such as bolts, and clamped against the aircraft wing skin to provide fuel tank access sealing. FTAC are designed to meet a wide array of requirements, some of them are: no fuel leaks, fire resistance, resistance to a tire impact, resistance to impacts resulting from an UERF (Uncontained Engine Rotor Failure), EMH/lightning strike, seal friction, and wing bending. The current design approach to address the resistance of the structure to an impact, for example, a tire impact, is to have heavy and stiff outer FTACs along with large diameter bolts to absorb the impact energy so that it is not transmitted to the inner FTAC and the sealing integrity of the structure is not compromised

The technical problem encountered in current solutions is that FTACs are too heavy. Another problem is the surrounding mounting structure may be damaged which could create repair issues.

Therefore, there is a need to find a solution for FTACs which decreases weight in an aircraft and which prevents the impact energy of an impact on the outer FTAC to reach an inner FTAC in an aircraft. There is also a need to prevent damage to the manhole mounting structure.

The mentioned prior art approach is seen in the patent U.S. Pat. No. 4,291,816 A wherein a fluid tight closure for an aperture, adapted to form a fuel tank access door for an aircraft, and providing fail-safe features and resistance to lightning strikes is described.

Other patent documents describing different solutions in aircrafts approaching absorption of impact energy and or designing FTAC and fuel tank access covers accomplishing the required characteristics taken into account in the state of the art are: EP 1 628 877 B1, U.S. Pat. No. 5,316,167, US 2001/0010345, US 2007/0207421, US 2012/0217347, U.S. Pat. No. 4,291,816.

In addition, other objects, desirable features and characteristics will become apparent from the subsequent summary and detailed description, and the appended claims, taken in conjunction with the accompanying drawings and this background.

### SUMMARY

The various teachings of the present disclosure provides a solution for the aforementioned problems. In one of various aspects of the present disclosure, it is presented an outer fuel tank access cover (FTAC) of an aircraft comprising an inner surface, an outer surface, and the outer FTAC adapted for being used to cover the outer opening of a void area of a manhole for accessing the interior of a wing of an aircraft wherein the interior of the wing comprises a fuel tank. The The outer FTAC comprises absorption means adapted for absorbing the impact energy due to an object impacting against the outer FTAC.

The absorption of the impact energy is in one example, carried out by plastic deformation of the outer FTAC provided by the present disclosure.

The present disclosure approaches the technical problems described by providing an outer FTAC that intends to improve its sealing performance after an impact and is lighter with respect to current designs.

Advantageously, this approach reduces the energy transferred to the inner FTAC cover and surrounding wing. The absorption of impact energy is achieved by converting the kinetic energy of the impacting fragment to work energy and heat by means of a plastic deformation of certain parts of the FTAC described.

The advantage of this solution over current designs is that the impact energy is mostly absorbed by the outer FTAC, minimizing the damage to the support structure, which ensures that sealing performance around the outer FTAC is fulfilled.

One of various aspects of the present disclosure provides a wing of an aircraft comprising at least one fuel tank access comprising an outer FTAC according to the various aspects of the present disclosure.

One of various aspects of the present disclosure provides an aircraft comprising a wing according to the various aspect of the present disclosure.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1A illustrates an exemplary embodiment of an aircraft wherein the left wing is shown in black.

FIG. 1B illustrates the locations of the wing of the aircraft shown in FIG. 1A where the FTACs are located.

FIG. 1C illustrates an exemplary embodiment of an outer FTAC according to the state of the art is represented.

FIG. 1D is a sectional view of the inner area of the wing wherein the fuel tank is located is represented and the relative position of the FTACs to the fuel tank is shown. The various embodiments of the present disclosure are located on the outer FTAC.

FIG. 1E is a zoomed view of FIG. 1D where the inner FTAC and outer FTAC are joined by means of bolts and the inner FTAC is shown to be sealed to the wing skin with fuel seals.

FIGS. 2A and 2B illustrate two views of an exemplary embodiment of the present disclosure where a frangible line is visible on the inner surface of an outer FTAC. In FIG. 2B one embodiment is shown wherein the FTAC comprises a rip stop feature.

FIGS. 3A, 3B, 3C, 3D, 3E and 3F illustrate various frangible line patterns.

FIG. 4 illustrates an exemplary embodiment of an outer FTAC which comprises a foam core between two layers of aluminum.

FIG. 5 is a comparative graphic, wherein different levels of energy absorbed per second having different absorption means are illustrated.

FIG. 6 illustrates an outer FTAC including a stitched frangible line.

FIG. 7 illustrates an outer FTAC including a zigzagged frangible line.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

Once the object of the present disclosure has been outlined, specific non-limitative embodiments are described hereinafter.

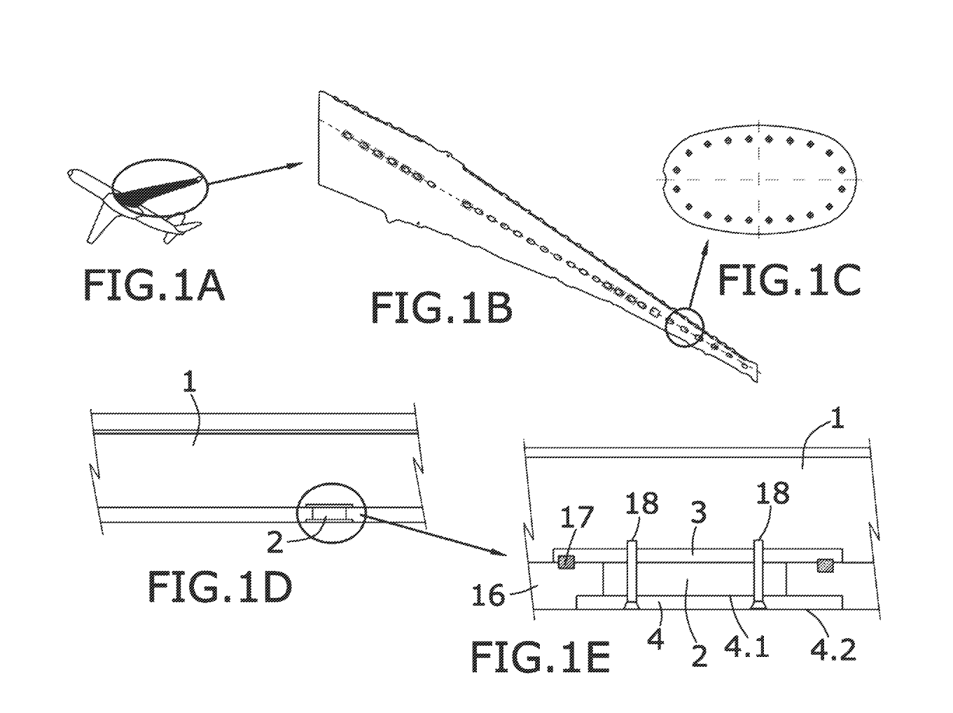

An exemplary embodiment of an aircraft is represented in FIG. 1A and its left wing is shown in FIG. 1B where the locations where the FTACs (FIG. 1C) are located are shown. In FIG. 1D a sectional view of the inner area of the wing wherein the fuel tank (1) is located is represented. Besides, in FIGS. 1D and 1E the relative position of the FTACs to the fuel tank (1) is shown. The inner FTAC (3) is in the fuel tank (1) and it is sealed with fuel seals (17) to the lower wing skin (16). The outer FTAC (4) is fixed to the lower wing skin (16) by means of a plurality of mounting holes peripherally distributed. The fixing means (18), or fasteners, in an embodiment of the present disclosure, are bolts.

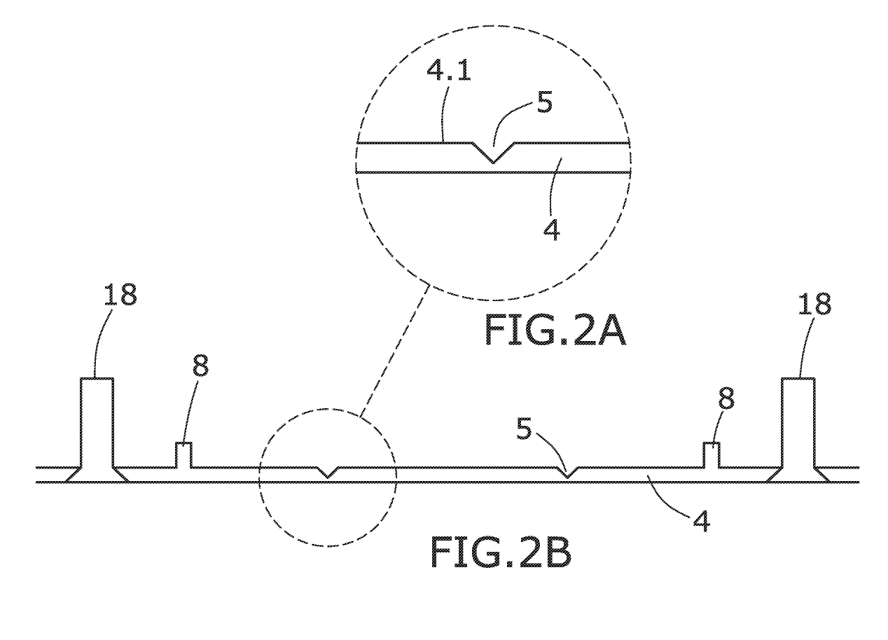

In an embodiment of the present disclosure, the outer FTAC (4) comprises energy-absorption means which are at least one frangible line (5) located on the inner surface (4.1) of the outer FTAC (4) and calibrated for being ruptured once a predetermined level of energy due to an impact is reached on the inner surface (4.1) of the outer FTAC (4). The frangible line is, in one embodiment of the present disclosure, a v-shaped groove scratched on the inner surface (4.1) of the outer FTAC (4), as it can be seen on FIG. 2.

In an embodiment of the present disclosure, the outer FTAC (4) is characterized in that the frangible line (5) is zigzag shaped. Advantageously, the zigzag shape changes the load direction abruptly and creates stress risers aiding in the cracking process.

In an embodiment of the present disclosure, the outer FTAC (4) is characterized in that the frangible line (5) defines a closed region (6) within the inner surface (4.1) of the outer FTAC (4). This frangible line (5) defining a closed region (6) advantageously creates a high stress riser that crack upon an impact event and, once the cracks propagate, the outer FTAC (4) plasticly deforms and therefore absorbs the impact energy.

Another advantage provided by the solution proposed is that deformable or crumble zones are created on the outer FTAC (4) so that it yields and plastically deforms. These deformation zones are created by the frangible line (5) and it is designed to break at certain energy ranges so that the outer FTAC (4) deforms and breaks in a controlled manner. The majority of the energy is absorbed by the outer FTAC (4) and advantageously it maintains sealing integrity of inner sealing of the outer FTAC (4). Advantageously, the solution also reduces the amplitude of the propagation impact wave that is transferred to the inner FTAC (3), so that sealing integrity is fulfilled.

In an exemplary embodiment of the present disclosure, the outer FTAC (4) is characterized in that it comprises at least an extra frangible line (7). The at least an extra frangible line (7) is, in one embodiment, inside the closed region (6).

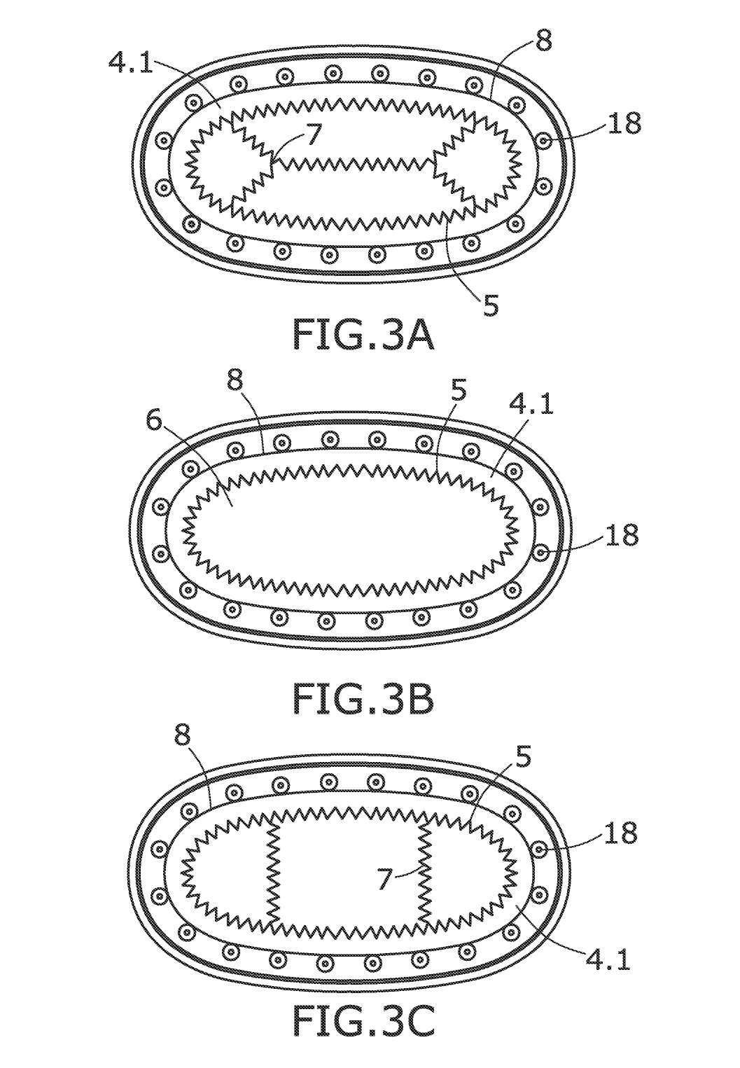

In an embodiment of the present disclosure, the outer FTAC (4) is characterized in that the closed region (6) is ellipse-shaped and zigzagged, and the at least one extra frangible line (7) is zigzagged as it can be seen in FIGS. 3A, 3B and 3C.

In an exemplary embodiment of the present disclosure, the outer FTAC (4) is characterized in that the closed region (6) is ellipse-shaped and stitched, and the at least one extra frangible line (7) is stitched as it can be seen in FIGS. 3D, 3E and 3F.

In the context of the present disclosure, the stitched feature of the frangible line must be understood as a succession of notches or small weakened areas having less thickness than the one of the outer FTAC (4).

In an exemplary embodiment of the present disclosure, the outer FTAC (4) is characterized in that it comprises a stiffener ring means (8) on the inner surface (4.1). Advantageously having a closed region (6) and stiffener ring means (8) makes the crack be contained within the stiffener ring means (8).

In an embodiment of the present disclosure, the outer FTAC (4) is characterized in that the stiffener means (8) are a stiffener ring (8) surrounding all the frangible lines (5, 7) on the inner surface (4.1). The stiffener ring (8) is part of the inner surface (4.1) of the outer FTAC (4) located in the interior perimeter defined by the line of bolts (18). Advantageously, this stiffener ring (8) acts as a rip stop so the cracks do not propagate to the fasteners or bolts. Advantageously, the fuel sealing integrity is maintained since the clamping force between the inner FTAC (3) and the outer FTAC (4) is maintained.

In an embodiment of the present disclosure, the outer FTAC (4) is made of metal.

In an embodiment of the present disclosure, the outer FTAC (4) is made of composite.

In one embodiment of the present disclosure the the outer FTAC (4) comprises absorption means which are at least one layer (10, 11) of a rigid material.

In one embodiment of the present disclosure the absorption means are the outer FTAC (4) and it comprises at least one layer (10, 11) of a rigid material.

In an exemplary embodiment of the present disclosure the absorption means are the outer FTAC (4) and the absorption means comprise a piece (9) made of a low density material forming the outer FTAC (4).

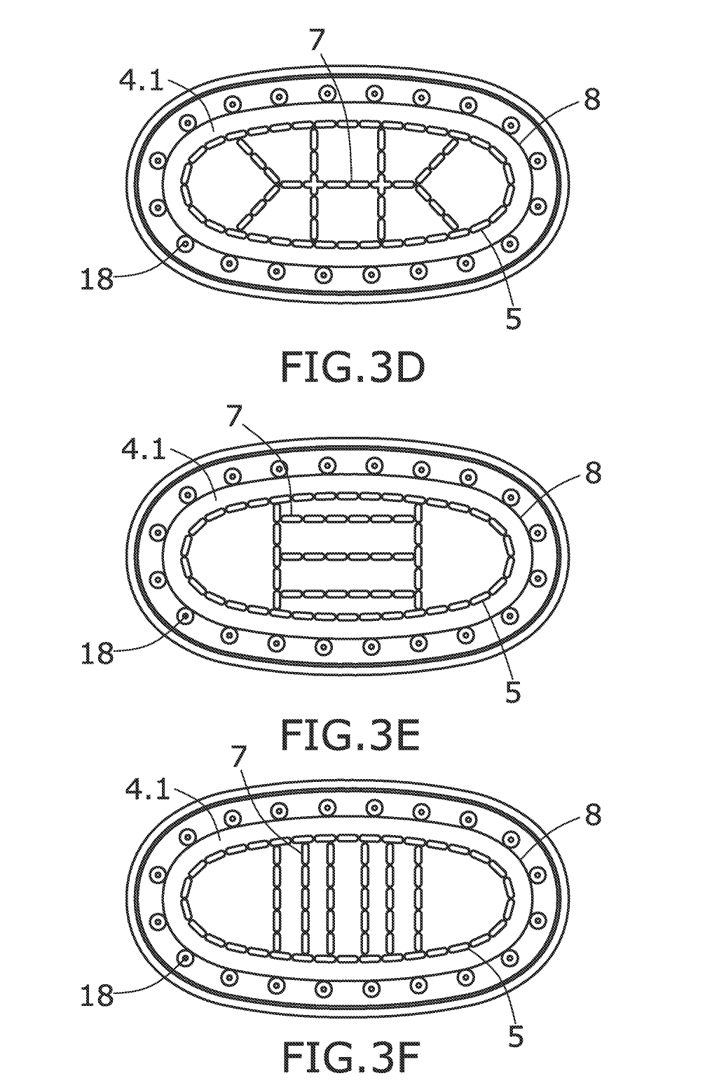

In an embodiment of the present disclosure the absorption means are the outer FTAC (4), and comprise a piece (9) made of low density material sandwiched between two layers (10, 11) of a rigid material, as shown in FIG. 4. FIG. 4, even not being scaled, represents an outer FTAC (4) made of the two layers (10, 11) of a rigid material with a piece (9) of a low density material. The outer FTAC (4) adapted for being fixed with the bolts (18) into the wing skin (16) in the aircraft. Advantageously, in the event of an impact, the outermost layer (11) receives the impact, the piece (9) of a low density material absorbs the main percentage of the impact, and the inner layer (10) provides rigidity to the whole structure.

In an embodiment of the present disclosure, the outer FTAC (4) is characterized in that the low density material is foam.

In an exemplary embodiment of the present disclosure, the outer FTAC (4) is characterized in that the two layers (10, 11) are aluminium layers, and the piece (9) is made of foam and sandwiched between the two layers (10, 11) of aluminium, as it can be seen in FIG. 4. In one embodiment the foam is Rohacell®. Advantageously this embodiment yields weight saving opportunities.

In an embodiment of the present disclosure, the outer FTAC (4) is characterized in that the two layers (10, 11) are made of glass fibre reinforced plastic (GFRP).

Advantageously, the solution having the two layers (10, 11) either made of aluminium or GFRP comprises the following advantages: no complex manufacturing, aerodynamic features, and low weight.

The solutions reduce the impact energy transferred to the outer FTAC (4) and surrounding wing skin (16). The reduction of impact energy is achieved by converting the kinetic energy of the impacting fragment, for instance a tire fragment, into work-energy and heat by plastically deforming the outer FTAC (4).

### Exemplary Embodiment

A detailed structural analysis and testing have been performed testing the outer FTAC (4) of the present disclosure which received the impact of an aircraft tire fragment. Various frangible lines (5) patterns, some of them shown in FIGS. 3A, 3B, 3C, 3D, 3E and 3F, have been analyzed using structural analysis software to determine the different energy absorption characteristics for each solution.

In FIG. 4 an outer FTAC (4) is represented comprising a foam piece (9) between two layers (10, 11) of aluminium, the upper or inner layer (10) of aluminium being 2 mm thick and the lower or outermost layer (11) being 1 mm thick.

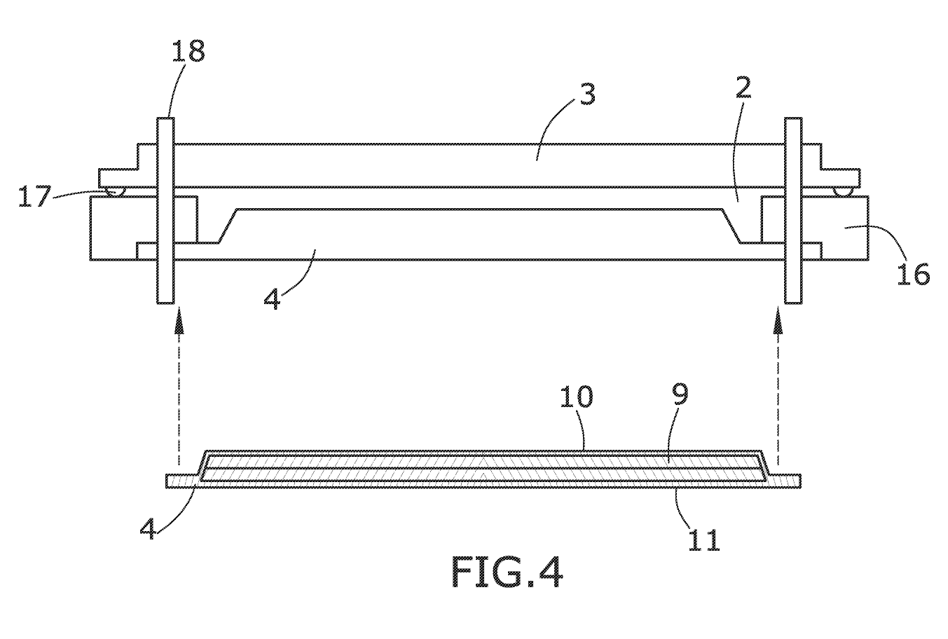

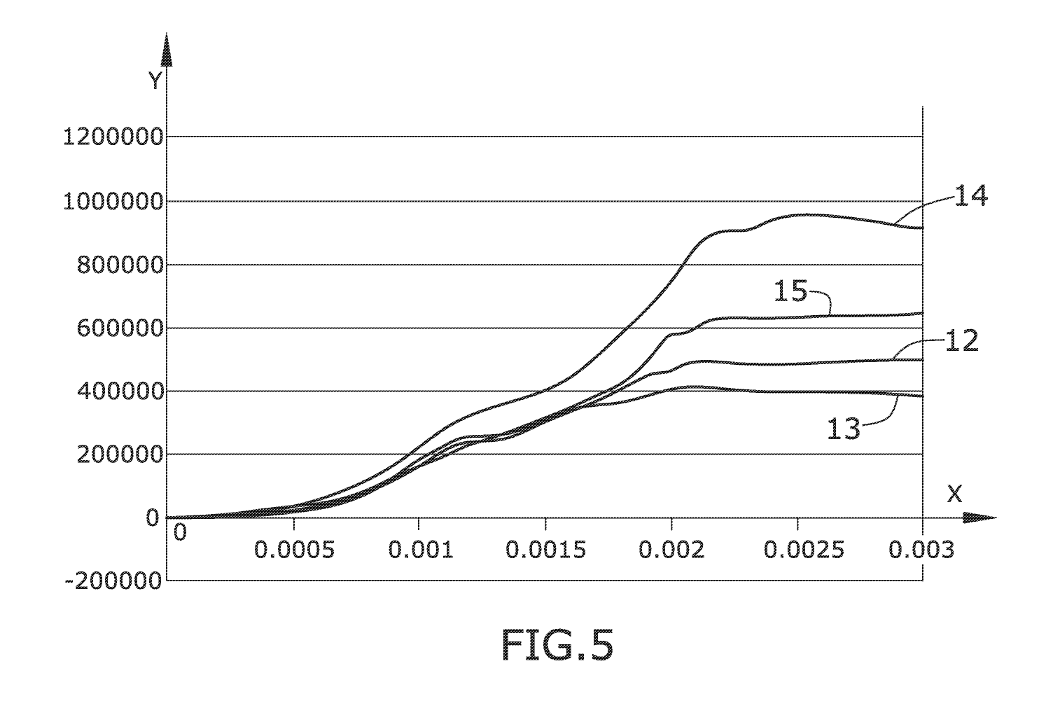

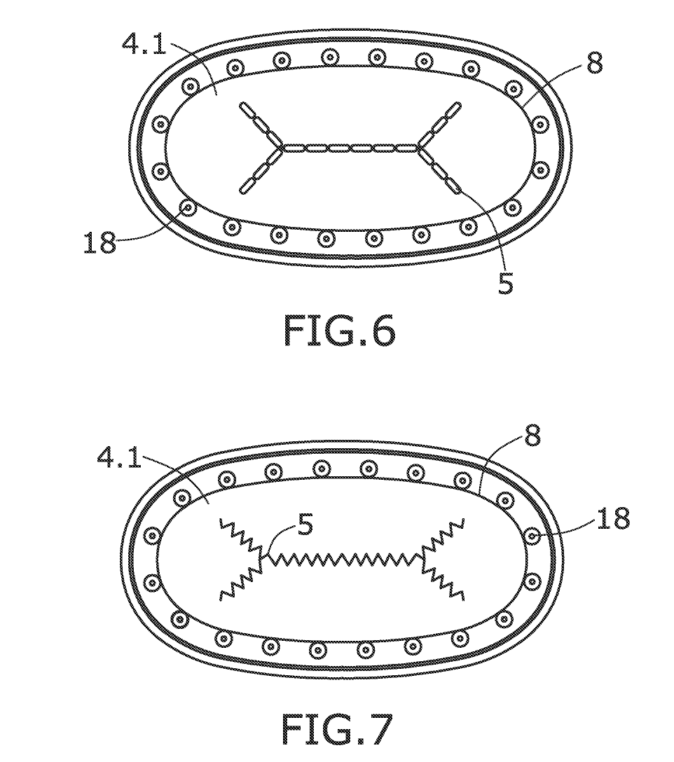

The exemplary embodiment of an outer FTAC (4) comprising a foam core (9) between the two layers of aluminium (10, 11) analytically shows the major absorbed impact energy. In FIG. 5 the absorbed impact energy, in joules (axis Y represents Energy in joules) per second (axis X represents time). The legend of such Fig. is as follows:
(12): Absorbed tire impact energy by an outer FTAC comprising a zigzagged frangible line as shown in FIG. 7.
(13): Absorbed tire impact energy by an outer FTAC (4) comprising a stitched frangible line (5) as shown in FIG. 6.
(14): Absorbed tire impact energy by an outer FTAC (4) comprising a foam piece (9) between two layers (10, 11) of aluminium, as shown in FIG. 4.
(15): Absorbed tire impact energy by an outer FTAC (4) comprising a frangible ellipse and zigzagged line (5) and a straight zigzagged frangible line (7), as shown in FIG. 3A.

The rising conclusions are: the zigzag pattern provides better results than the stitched pattern, the closed ellipse (5) also provides better results than having a single frangible line (7), and the best performance is provided by a foam piece (9) between two layers (10, 11) of aluminium, as shown in FIG. 4.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. An outer fuel tank access cover for covering an outer opening of a void area of a manhole for accessing an interior of a wing of an aircraft that includes a fuel tank, the outer fuel tank access cover comprising:
an inner surface, and
an outer surface,
wherein the outer fuel tank access cover comprises absorption means for absorbing the impact energy due to an object impacting against the outer fuel tank access cover.

2. The outer fuel tank access cover according to claim 1, wherein the absorption means are at least one frangible line located on the inner surface of the outer fuel tank access cover and calibrated for being ruptured once a predetermined level of energy due to an impact is reached.

3. The outer fuel tank access cover according to claim 2, wherein the at least one frangible line is zigzag shaped.

4. The outer fuel tank access cover according to claim 2, wherein the at least one frangible line defines a closed region within the inner surface of the outer fuel tank access cover.

5. The outer fuel tank access cover according to claim 2, wherein the outer fuel tank access cover comprises at least one second frangible line.

6. The outer fuel tank access cover according to claim 4 wherein the closed region is ellipse-shaped.

7. The outer fuel tank access cover according to claim 2, wherein the outer fuel tank access cover comprises a stiffener.

8. The outer fuel tank access cover according to claim 7, wherein the stiffener is a stiffener ring surrounding the at least one frangible line on the inner surface.

9. The outer fuel tank access cover according to claim 1, wherein the outer fuel tank access cover is made of metal.

10. The outer fuel tank access cover according to claim 1, wherein the absorption means comprises at least one layer of a rigid material in the outer fuel tank access cover.

11. The outer fuel tank access cover according to claim 1, wherein the absorption means comprise at least one piece made of a low density material.

12. The outer fuel tank access cover according to claim 11, wherein the piece made of a low density material is sandwiched between the two layers of a rigid material.

13. The outer fuel tank access cover according to claim 12, wherein the two layers are aluminum layers and the piece made of a low density material is made of foam.

14. A wing of an aircraft, comprising:
a fuel tank; and
a fuel tank access covering the fuel tank and including an outer fuel tank access cover, the outer fuel tank access cover including an inner surface and an outer surface,
wherein the outer fuel tank access cover comprises an energy absorption area for absorbing the impact energy due to an object impacting against the outer fuel tank access cover.

15. An aircraft, comprising:
a wing including a fuel tank and a fuel tank access covering the fuel tank, the fuel tank access including an outer fuel tank access cover, the outer fuel tank access cover including an inner surface and an outer surface,
wherein the outer fuel tank access cover comprises at least one frangible line located on the inner surface of the outer fuel tank access cover that is calibrated for being ruptured once a predetermined level of energy due to an impact is reached.

16. The outer fuel tank access cover according to claim 5 wherein the at least one second frangible line is zigzaged.

17. The outer fuel tank access cover according to claim 8, wherein the stiffener ring is located within an interior perimeter of the outer fuel tank access cover, which is defined by a line of bolts.

18. The wing according to claim 14, wherein the energy absorption area includes at least one frangible line located on the inner surface of the outer fuel tank access cover and calibrated for being ruptured once a predetermined level of energy due to an impact is reached.

19. The wing according to claim 18, wherein the at least one frangible line is zigzag shaped.

20. The aircraft according to claim 15, wherein the at least one frangible line defines a closed region within the inner surface of the outer fuel tank access cover.
